(19) United States
(12) Patent Application Publication
(10) Pub. No.: US 2006/0132330 A1
(43) Pub. Date: Jun. 22, 2006

(54) Telemetry system and method using single shared address

(75) Inventor: Young-Han Youn, Seongnam-si (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: HuneTec Co. Ltd, Seongnam-si (KR)

(21) Appl. No.: 11/142,868

(22) Filed: Jun. 1, 2005

(30) Foreign Application Priority Data
Dec. 22, 2004 (KR) 10-2004-0110024

(51) Int. Cl. H04Q 9/00; G08C 19/22

(52) U.S. Cl. 340/870.07

(57) ABSTRACT

Disclosed herein are a telemetry system and method that can communicate with a plurality of telemetric devices, which manage and control watt-hour meters, water or gas meters, or vending machines, using a single shared address. The system includes a group of telemetric devices, a telemetric server and a two-way communication network. The group of telemetric devices are attached to the target devices, respectively, and are assigned a single shared address. The telemetric server remotely manages and controls the group of telemetric devices. The two-way communication network performs data communication between the group of telemetric devices and the telemetric server. The group of telemetric devices includes a plurality of telemetric devices located adjacent to each other in a specific area, one of the group of telemetric devices is set as a master telemetric device and remaining ones are set as slave telemetric devices, and the master telemetric device and the slave telemetric devices are assigned unique sub-IDs.

### BACKGROUND OF THE INVENTION

1. Field of the Invention

The present invention relates generally to a telemetry system and method and, more particularly, to a telemetry system and method that are capable of communicating with a plurality of telemetric devices, which manage and control watt-hour meters, water or gas meters, or vending machines, using a single shared address.

2. Description of the Related Art

In general, reflex communication mainly uses 4-level Frequency Shift Keying (FSK) modulation and demodulation. An address is assigned to each communication device that performs reflex communication, and frequency information used to set up a communication connection to a communication network is stored in the memory of the communication device, so that the communication device performs communication registration with the communication network using the frequency information. Accordingly, a reflex type communication network sets up a communication connection by transmitting a grant command to the communication device when the frequency information received from the communication device is valid.

Meanwhile, unlike one-way communication, in two-way communication, a response signal must be transmitted whenever data have been transmitted, so that communication devices connect to a communication network using unique addresses, and cannot use a single shared address.

In such a two-way data communication network, approval and response are performed whenever every data is transmitted, and transmittable frames are previously determined for respective addresses so as to prevent collisions when communication devices transmit data, so that an address must be assigned to each of the communication devices.

For example, a reflex protocol is composed of 128 frames having a period of four minutes, and 128 frames constitute one cycle, so that 15 cycles are one hour. Accordingly, the process returns to cycle 0 after cycle 14, the structure of which is illustrated in FIG. 1.

Meanwhile, frames through which control data for the communication devices are received and frames through which the communication devices can transmit data are determined by Block Information Words (BIWs) that are transmitted at regular periods to synchronize with addresses stored in the communication devices on the communication network.

However, in the case where the transmission and reception of data are not urgent and data are transmitted and received via a communication network one or two times per day or month, the assignment of one address to each communication device not only reduces the efficiency of use of addresses but also inefficiently wastes addresses.

For example, a telemetric device, which reads the amount of power calculated by a watt-hour meter and transmits the read value to a telemetric server via a communication network, reads the amount of water used as measured by a water meter and transmits the read value to the telemetric server via the communication network, reads the amount of gas used as measured by a gas meter and transmits the read value to the telemetric server via the communication network, or reads the number of cans remaining in a vending machine and transmits the read value to the telemetric server via the communication network, transmits and receives data one or two times per day or month. Accordingly, the assignment of one address to each telemetric device reduces the efficiency of use of addresses in view of expenses incurred by the assignment of addresses. Due to the above-described problem, a technology of managing and controlling watt-hour meters, water meters, gas meters or vending machines has not been commercialized yet.

### SUMMARY OF THE INVENTION

Accordingly, the present invention has been made keeping in mind the above problems occurring in the prior art, and an object of the present invention is to provide a telemetry system and method that are capable of communicating with a plurality of telemetric devices, which manage and control watt-hour meters, water or gas meters or vending machines, using a single shared address.

Another object of the present invention is to provide a telemetry system and method, in which a plurality of telemetric devices communicates using a single shared address without collisions between data as if they had respective addresses, thus improving the efficiency of use of addresses.

Another object of the present invention is to provide a telemetry system and method, in which a plurality of telemetric devices uses a single shared address, thus considerably reducing the cost of communication that is required for the performance of telemetry via a communication network.

In order to accomplish the above object, the present invention provides a telemetry system for managing and controlling a plurality of target devices, such as vending machines; water meters, gas meters and watt-hour meters, the system including a plurality of slave telemetric devices each of which is attached to each of the target devices, communicates with the communication network using a single shared address in RF signal form, collects and stores information about the target device to which the slave telemetric device is attached, manages and controls the target device, and transmits a message containing stored information via the communication network in RF signal form as a message request command requesting the information and a sub-ID of the slave telemetric device are received via the communication network; a master telemetric device that is attached to one of the target devices, uses the shared address with the slave telemetric devices, communicates with the communication network using the shared address, manages the slave telemetric devices via the communication network, transmits a response providing notification of reception of message request command and a certain command via the communication network in Radio Frequency (RF) form when the message request command or the certain command is received at the shared address via the communication network, collects and stores information about a target device to which the master telemetric device is attached, manages and controls the target device, and transmits a message containing stored information via the communication network in RF signal form as a message request command requesting the information and a sub-ID of the master telemetric device are received via the communication network; and a telemetric server that transmits the shared address, the sub-IDs of the master telemetric device and the slave telemetric devices, the message request command and the certain command to the master telemetric device and the slave telemetric devices via the communication network, and receives commands and messages from the master telemetric device and the slave telemetric devices via the communication network.

In addition, the present invention provides a telemetry method of remotely reading and managing target devices, such as vending machines, water or gas meters, or watt-hour meters, using a telemetric server communicating with a master telemetric device and slave telemetric devices attached to the target devices, respectively, via a two-way communication network, the method including; a step 1 at which at least one of the master telemetric device and the slave telemetric devices transmits a transmission request command providing notification of transmission of a message to the communication network using a shared address in advance, and transmits the message containing certain information to the communication network in RF signal form as a reception termination command approving the transmission of the message to the shared address is received from the communication network in response to the transmission request command; a step 2 at which at least one of the master telemetric device and the slave telemetric devices transmits a normal response command providing notification of the normal reception of the message to the communication network in RF signal form as the communication network transmits a message termination command providing notification of termination of reception of the message using the shared address in response to the transmission request command; a step 3 at which the master telemetric device transmits a reception response command providing notification of reception of message request command to the telemetric server via the communication network in RF signal form as the telemetric server transmits the message request command requesting information using the shared address and a sub-ID of at least one of the master telemetric device and the slave telemetric devices via the communication network; and a step 4 at which one of the master telemetric device and the slave telemetric devices, which has a sub-ID coinciding with the sub-ID transmitted from the telemetric server, executes the message request command transmitted by the telemetric server.

In addition, the present invention provides a telemetric device attached to a target device, such as a vending machine, water or gas meter, or a watt-hour meter, and configured to manage and control the target device and exchange messages and various commands with a telemetric server via a two-way communication network, the telemetric device including storage means for storing a shared address, information about the target device, a sub-ID for identification thereof, frame information for prevention of collisions between transmitted data, a flag for distinguishing between a master and a slave and frequency information for communication with the communication network; control means for performing control using the frequency information stored in the storage means so that the telemetric device and the communication network communicates in synchronization with each other, storing information, which is provided via the communication network, in the storage means, collecting information about the target device and storing the information about the target device in the storage means, providing the information stored in the storage means and controlling the target device in compliance with a command of the telemetric server received via the communication network, and transmitting information via the frames stored in the storage means; and Radio Frequency (RF) transmission and reception means for converting an RF signal, which is received from the communication network, into a digital baseband signal and transferring the digital baseband signal to the control means, and converting a digital baseband signal, which is transferred from the control means, into an analog RF signal and transmitting the analog RF signal to the communication network, under control of the control means.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the format of a frame that constitutes a general reflex protocol;

FIG. 2 is a schematic diagram showing a telemetry system using a single shared address in accordance with an embodiment of the present invention;

FIG. 3 is a diagram showing the construction of a telemetric device according to an embodiment of the present invention;

FIG. 4 is a diagram showing a process of communication between the telemetric device and a communication network according to the present invention;

FIG. 5 is a diagram showing a process of data transmission and reception between the telemetric device and a telemetric server according to the present invention; and

FIGS. 6a and 6b are flowcharts showing a telemetry method using a single shared address in accordance with an embodiment of the present invention.

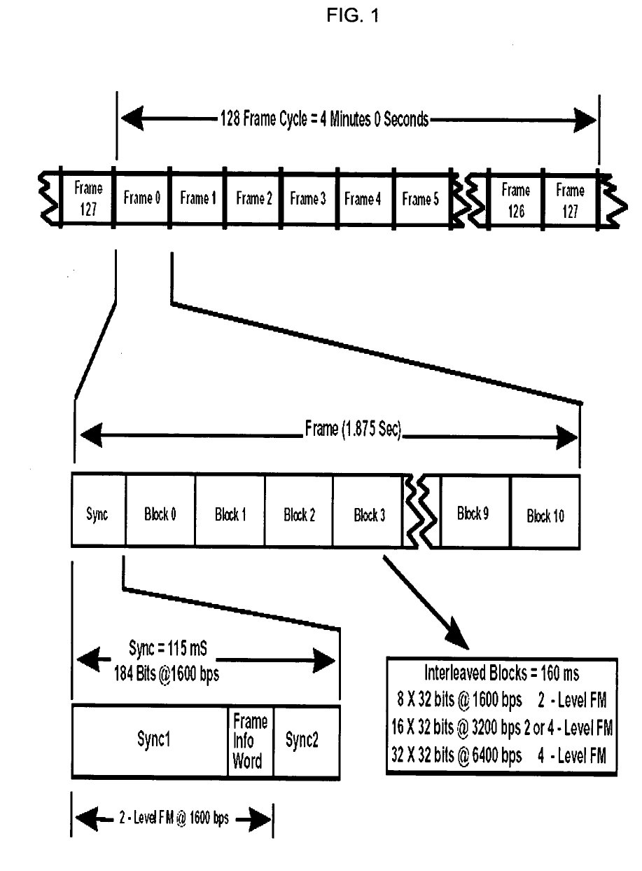

### DESCRIPTION OF THE PREFERRED EMBODIMENTS

Reference now should be made to the drawings, in which the same reference numerals are used throughout the different drawings to designate the same or similar components.

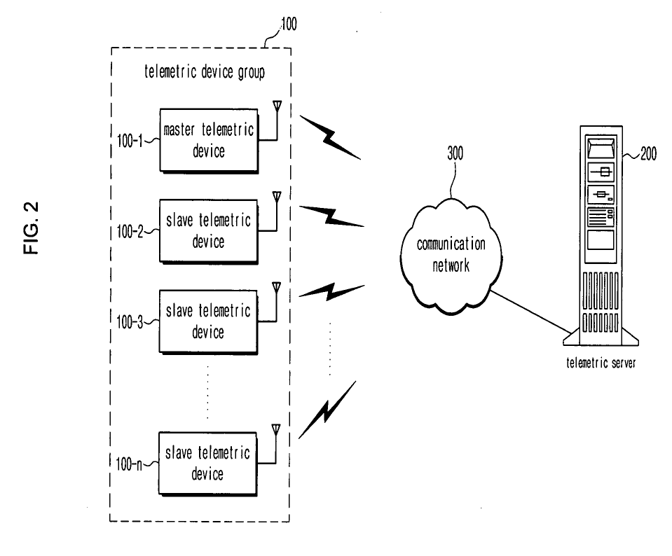

FIG. 2 is a schematic diagram showing a telemetry system using a single shared address in accordance with an embodiment of the present invention.

Referring to FIG. 2, the telemetry system of the present invention includes a group of telemetric devices 100 for managing and controlling watt-hour meters, water or gas meters and vending machines, a telemetric server 200 for remotely managing and controlling the group of telemetric devices 100, and a communication network 300 for performing data communication between the group of telemetric devices 100 and the telemetric server 200.

The group of telemetric devices 100 includes a plurality of telemetric devices 100-1 to 100-n that are located adjacent to each other in a specific area. The group of telemetric devices 100 is composed of a master telemetric device 100-1 and a plurality of slave telemetric devices 100-2 to 100-n, and performs data communication with the telemetric server 200 via the communication network 300 using a single shared address.

A flag for allowing the master telemetric device 100-1 to function as a master is set for the master telemetric device 100-1, and a flag for allowing the plurality of slave telemetric devices 100-2 to 100-n to function as slaves is set for the plurality of slave telemetric devices 100-2 to 100-n. Master and slave functions are distinguished from each other by the flags.

Sub-IDs are assigned to the plurality of telemetric devices 100-1 to 100-n, respectively. It is preferable to assign sub-IDs to telemetric devices 100-1 to 100-n in ascending order of Arabic numerals on the basis of the master telemetric device 100-1. In an example of the assignment of sub-IDs, sub-ID 1 may be assigned to the master telemetric device 100-1, sub-ID 2 may be assigned to the slave telemetric device 100-2, sub-ID 3 may be assigned to the slave telemetric device 100-3, and sub-ID n may be assigned to the slave telemetric device 100-n. By assigning sub-IDs in the above-described manner, each of the telemetric devices 100-1 to 100-n can perform one-to-one communication with the telemetric server 200 using a sub-ID assigned thereto even though the group of telemetric devices 100 use a single shared address. That is, since the telemetric server 200 requests data using the shared address when requesting the data from the group of telemetric devices 100, the data request signal of the telemetric server 200 is transmitted to all of the telemetric devices 100 via the communication network 300, but only the telemetric device to which a corresponding sub-ID is assigned transmits the requested data in response to the data request signal of the telemetric server 200 because the telemetric server 200 transmits the data request signal with the sub-ID attached thereto. At this time, other telemetric devices, to which the sub-ID attached to the data request signal is not assigned, do not respond to the data request signal.

For example, when the telemetric server 200 transmits a data request signal with sub-ID 2 attached thereto to the group of telemetric devices 100 via the communication network 300, only the slave telemetric device 100 to which sub-ID 2 is assigned responds to the data request signal and transmits requested data to the telemetric server 200 via the communication network 300 in response to the data request signal. At this time, the telemetric devices 100-1, 100-3 to 100-n having other sub-IDs do not respond to the data request signal of the telemetric server 200. Meanwhile, the telemetric server 200 can attach two or more sub-IDs to a data request signal. Accordingly, if the telemetric server 200 attaches all of the sub-IDs assigned to the group of telemetric devices 100 to a data request signal and transmits the data request signal to the group of telemetric devices 100 via the communication network 300, all of the telemetric devices 100-1 to 100-n of the group of telemetric devices 100 transmit requested data to the telemetric server 200 via the communication network 300 in response to the data request signal.

The data format, in which a sub-ID is attached to a command that is desired to be transmitted to the group of telemetric devices 100 by the telemetric server 200, is illustrated below.

<Data Format>

| | | | | | | |
|---|---|---|---|---|---|---|
| D₁ | D₂ | D₃ | D₄ | D₅ | D₆ | D₇ |

In the data format, D1 and D2 are sub-ID code, and D3 to D7 are commands. D1 to D7 are each composed of 7-bit American Standard Code for Information Interchange (ASCII) code.

When the telemetric server 200 transmits a command with a sub-ID attached thereto to the group of telemetric devices 100 via the communication network 300, the telemetric device having the sub-ID responds. When the communication network 300 transmits a communication request command requesting a current communication connection setup to the group of telemetric devices 100 using the shared address, only the master telemetric device 100-1 responds to the communication request command, but other telemetric devices 100-2 to 100-n, that is, the slave telemetric devices 100-2 to 100-n, do not respond to the communication request command directly transmitted from the communication network 300. In this case, when the master telemetric device 100-1 transmits a communication approval signal approving communication to the communication network 300 in response to the communication request command, the communication network 300 sets up a communication connection with the master telemetric device 100-1, and further automatically sets up a communication connection with the slave telemetric devices 100-2 to 100-n that share the address with the master telemetric device 100-1. That is, in the present invention, in response to a command transmitted by the communication network 300 to perform communication, only the master telemetric device 100-1 responds, but the slave telemetric devices 100-2 to 100-n do not respond.

In the meantime, the telemetric devices 100-1 to 100-n and the communication network 300 perform communication using a certain frequency, so that the telemetric devices 100-1 to 100-n store information about the certain frequency that is used for communication. Accordingly, when power is turned on, that is, when a communication connection with the communication network 300 is not set up, the master telemetric device 100-1 requests communication registration from the communication network 300 using the certain frequency information. When the communication network 300 approves communication at the request of the master telemetric device 100-1, the communication connection between the master telemetric device 100-1 and the communication network 300 is set up. In this case, communication connections between the slave telemetric devices 100-2 to 100-n and the communication network 300 are automatically set up, so that the slave telemetric devices 100-1 do not additionally request communication registration from the communication network 300. When the communication connections are set up between the group of telemetric devices 100 and the communication network 300, the group of telemetric devices 100 and the telemetric server 200 perform data communication via the communication network 300.

Furthermore, the master telemetric device 100-1 stores information about the number of slave telemetric devices that pertain to the group of telemetric devices 100 managed by the master telemetric device 100-1. Using the information, the master telemetric device 100-1 manages the slave telemetric devices 100-2 to 100-n pertaining to the group of telemetric devices 100 via the communication network 300. As an example of the management, when the telemetric server 200 requests data from the slave telemetric device 100-2 having sub-ID 2 using the shared address, a data request signal transmitted from the telemetric server 200 is simultaneously transmitted to the telemetric devices 100-1 to 100-n using the shared address, so that the master telemetric device 100-1 checks whether the slave telemetric device 100-2 having the sub-ID 2 has received a data request. Furthermore, when the slave telemetric device 100-2 transmits requested data to the telemetric server 200 via the communication network 300, the communication network 300 notifies the master telemetric device 100-1 that the slave telemetric device 100-2 having the sub-ID 2 has transmitted the requested data. If the master telemetric device 100-1 has not been notified by the communication network 300 that the slave telemetric device 100-2 has transmitted the requested data within a certain period after the data request, the master telemetric device 100-1 directs the slave telemetric device 100-2 to provide the requested data to the telemetric server 200 via the communication network 300. In the above-described way, the master telemetric device 100-1 manages the slave telemetric device 100-2 to 100-n that pertains to the group of telemetric devices 100.

Meanwhile, in order to prevent collisions between data when the telemetric devices 100-1 to 100-n transmit data, the present invention sets different frames for respective sub-IDs assigned to the telemetric devices 100-1 to 100-n. For example, frames 0 to 15 are set for the master telemetric device 100-1 to which sub-ID 1 is assigned, frames 16 to 31 are set for the slave telemetric device 100-2 to which sub-ID 2 is assigned, and frames 32 to 47 are set for the slave telemetric device 100-3 to which sub-ID 3 is assigned. If the number of frames set for the group of telemetric devices 100 exceeds 128 because the number of sub-IDs assigned to the group of telemetric devices 100 is excessively large, data transmission is controlled, with the frames being specified for respective cycles. In this case, 128 frames constitute a single cycle, and 15 cycles are 1 hour. Accordingly, the process returns to cycle 0 after cycle 14. The specification of frames for transmission is based on the reflex protocol. Generally, the reflex protocol is composed of 128 frames having a period of four minutes.

The telemetric devices 100-1 to 100-n transmit information collected and stored by them to the telemetric server 200 at regular periods. The period of transmission of the information is set in advance, and may be arbitrarily changed by a user. In this case, the telemetric devices 100-1 to 100-n automatically transmit information at predetermined periods via determined frames even though they do not receive commands requesting data from the telemetric server 200.

The telemetric devices 100-1 to 100-n are attached to watt-hour meters, water and gas meters, and vending machines, and perform management and control functions. For example, when the telemetric devices 100-1 to 100-n are attached to respective water meters and manage and control the water meters, the telemetric devices 100-1 to 100-n collect and store the measured values of the water meters to which they are attached and information about whether errors have occurred, provide the collected measured values and information to the telemetric server 200 via the communication network 300 at the request of the telemetric server 200, and control the operation of the water meters, to which the telemetric devices 100-1 to 100-n are attached, in compliance with the instructions of the telemetric server 200.

The telemetric server 200 can be implemented to perform wired or wireless communication with the communication network 300. The case where the telemetric server 200 is connected to the communication network 300 in a wired manner in FIG. 2 is only one example of implementation.

The telemetric server 200 requests data from the group of telemetric devices 100 or transmits control signals to the group of telemetric devices 100 in compliance with the user's instructions, and transmits a command, to which a sub-ID designated by the user is attached, to the group of telemetric devices 100. Furthermore, the telemetric server 200 displays data provided by the group of telemetric devices 100 so that the user can view the data, and prints the data using a printer (not shown).

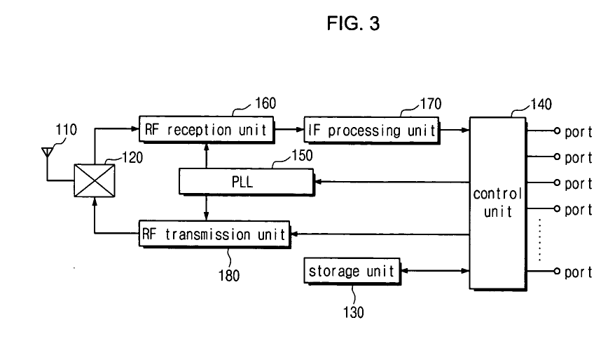

The construction of the telemetric device according to the present invention, which has the above-described function, is illustrated in FIG. 3.

Referring to FIG. 3, the telemetric device of the present invention includes an antenna 110 for transmitting and receiving Radio Frequency (RF) signals, a transmission and reception switch 120 for switching RF signals transmitted and received through the antenna 110, a storage unit 130 for storing a shared address, sub-IDs, flag information, frame information, frequency information, the period of transmission of information and various types of information, a control unit 140 for executing a variety of commands received from the communication network 300, receiving or collecting information from the outside and storing the received and collected information in the storage unit 130, performing communication with the communication network 300 using frequency information stored in the storage unit 130, transmitting information stored in the storage unit 130 according to the period of transmission stored in the storage unit 130 via frames stored in the storage unit 130, and controlling the frequency synchronization of RF signals to be transmitted and received, a Phase Locked Loop (PLL) 150 for generating frequency signals in a certain band under the control of the control unit 140, an RF reception unit 160 for converting RF signals received from the antenna 110 into Intermediate Frequency (IF) signals by mixing the RF signals received from the antenna 110 with the frequency signals output from the PLL 150, an IF processing unit 170 for converting the IF signals obtained by the RF reception unit 160 into baseband digital signals and outputting the baseband digital signals to the control unit 140, and an RF transmission unit 180 for converting baseband digital signals output from the control unit 140 into RF analog signals by mixing the baseband digital signals with frequency signals output from the PLL 150 and outputting the RF analog signals to the transmission and reception switch 120.

The transmission and reception switch 120 switches the RF signals received from the antenna 110 to the RF reception unit 160 and switches the RF signals output from the RF transmission unit 180 to the antenna 110.

The storage unit 130 stores the shared address assigned to the group of telemetric devices 100, various types of information transmitted by the control unit 140, a sub-ID used to identify itself, frame information used to prevent collisions between data, storing flags used to distinguish a master and a slave from each other, and storing frequency information used for communication with the communication network 300 and the period of transmission of information.

The storage unit 130 can be implemented using flash memory, Static Random Access Memory (SRAM) or Electronically Erasable Programmable Read Only Memory) EEPROM.

The control unit 140 controls the frequency generation of the PLL 150 using the frequency information stored in the storage unit 130 so that the telemetric device and communication network 300 of the present invention perform communication in synchronization with each other, stores information, which is provided via the communication network 300, in the storage unit 130, collects information about a target device to which the telemetric device of the present invention is attached and stores the information in the storage unit 130, provides the information stored in the storage unit 130 and controls the target device in compliance with the commands of the telemetric server 200 received via the communication network 300, performs a master function if the flag stored in the storage unit 130 indicates the master function or a slave function if the flag stored in the storage unit 130 indicates the slave function, and transmits information through the frame stored in the storage unit 130. If the period of transmitting at which data are automatically transmitted to the storage unit 130 is set, the control unit 140 transmits the information stored in the storage unit 130 at intervals corresponding to the period of transmission stored in the storage unit 130.

A plurality of ports is connected to the control unit 140, and the control unit 140 outputs control signals controlling the target device to which the telemetric device of the present invention is attached, receives data from the target device and stores the data in the storage unit 130.

For example, when the telemetric device of the present invention is attached to a water meter, the control unit 140 receives measured values from the water meter through the ports and stores the measured values in the storage unit 130, and controls the operation of the water meter in compliance with the command of the telemetric server 200 received via the communication network 300. At this time, the control unit 140 outputs control signals controlling the water meter via the ports. Furthermore, when the telemetric server 200 transmits a command requesting the measured values of the water meter via the communication network 300, the control unit 140 transmits the measured values of the water meter stored in the storage unit 130 to the telemetric server 200 in response to the command.

The IF processing unit 170 converts the IF signal, which is obtained by the RF reception unit 160, into a digital baseband signal suitable for the control unit 140, and demodulates a modulated signal and transmits a demodulated signal to the control unit 140.

The RF transmission unit 180 converts the digital baseband signal, which is output from the control unit 140, into an analog RF signal by mixing the digital baseband signal with a frequency signal output from the PLL 150, modulates the analog RF signal and outputs the modulated signal to the transmission and reception switch 120.

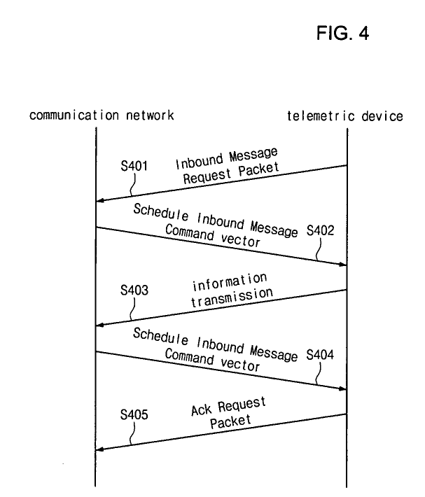

FIG. 4 is a diagram showing a process of communication between the telemetric device and the communication network according to the present invention.

Referring to FIG. 4, when the telemetric devices 100-1 to 100-n transmit a transmission request command (Inbound Message Request Packet), that is, a command providing notification of the current transmission of information collected and stored by them, to the communication network 300 at step S401, the communication network 300 transmits a transmission approval command (Schedule Inbound Message Command vector), that is, a command approving the transmission of a message containing information, to the telemetric devices 100-1 to 100-n at step S402.

When the approval for communication is made, the telemetric devices 100-1 to 100-n transmit messages (SAU&DU: START ADDRESS UNIT & DATA UNIT) containing the stored information to the communication network 300 at step S403, the communication network 300 having received the information transmits a reception termination command (Schedule Inbound Message Command vector), that is, a command providing notification of the normal reception of all transmitted messages, to the telemetric devices 100-1 to 100-n at step S404.

When the reception termination command (Schedule Inbound Message Command vector) is received, the telemetric devices 100-1 to 100-n transmit a normal response command (Ack Request Packet), that is, a command providing notification of the recognition of the normal reception of the messages, to the communication network 300 at step S405.

When the messages and commands are exchanged as described above, the telemetric device and communication network of the present invention have the following characteristics.

When the telemetric devices 100-1 to 100-n transmit message containing certain information to the communication network 300 via a reverse channel, the telemetric devices 100-1 to 100-n transmit a transmission request command (Inbound Message Request Packet) to the communication network 300. In such a reverse channel state, the telemetric device manages a Message Sequence Number (MSN), which indicates the transmission of messages, by counting the MSN whenever a message is transmitted, and transmits the MSN along with packet data.

Then, the communication network 300 transmits a transmission approval command (Schedule Inbound Message Command vector) in response to the transmission request command (Inbound Message Request Packet) received from the telemetric devices 100-1 to 100-n. The previously transmitted MSN is contained in this command. In compliance with the transmission approval command (Schedule Inbound Message Command vector), the telemetric devices 100-1 to 100-n transmit messages containing certain information according to predetermined communication rules. After all of the messages have been received, the communication network 300 provides notification by transmitting a reception termination command (Schedule Inbound Message Command vector) again. Thereafter, when the telemetric devices 100-1 to 100-n transmit a normal response command (Ack) in response to the reception termination command (Schedule Inbound Message Command vector), the transmission is completed.

In that case, the transmission approval command (Schedule Inbound Message Command vector) transmitted by the communication network 300 is received by all of the telemetric devices 100-1 to 100-n of the group of telemetric devices 100 because the telemetric devices 100-1 to 100-n have the same address. At this time, since the MSN is transmitted along with the transmission approval command (Schedule Inbound Message Command vector), the telemetric device transmitting a message containing certain information in response to the transmission approval command recognizes that the transmission approval command is transmitted to it and transmits an Ack. Other telemetric devices update MSNs contained therein with a received MSN.

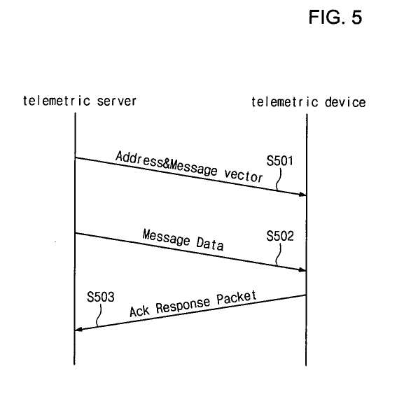

FIG. 5 is a diagram showing a process of data transmission and reception between the telemetric device and the telemetric server according to the present invention.

Referring to FIG. 5, the telemetric server 200 transmits an address signal (Address&Message vector), which is input by the user, to the telemetric devices 100-1 to 100-n via the communication network 300 at step S501, and the telemetric server 200 transmits a message request command (Message Data), that is, a command requesting data from an input address in compliance with the user's instruction, to the telemetric devices 100-1 to 100-n via the communication network 300, with the sub-ID of the telemetric device input by the user being attached to the message request command (Message Data), at step S502. When the message request command is received, the master telemetric device 100-1 transmits a reception response command (Ack Response Packet) providing notification of the reception of the message request command to the telemetric server 200 via the communication network 300 at step S503.

In the performance of the above-described process, the telemetric device to transmit a normal response command (Ack) must be designated because there are many telemetric devices 100-1 to 100-n in the group of telemetric devices 100. In this case, methods in which the telemetric devices respond include a method in which the master telemetric device 100-1 makes all of the responses and a method in which the telemetric device having the sub-ID attached to the message request command responds to the message request command. The present invention employs the method in which the telemetric device specified by the sub-ID responds to the message request command as described above.

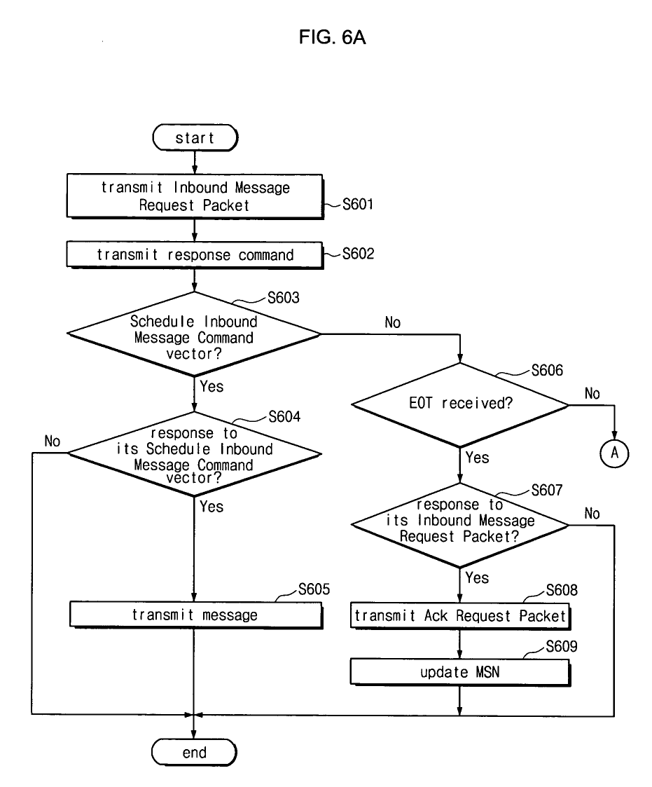

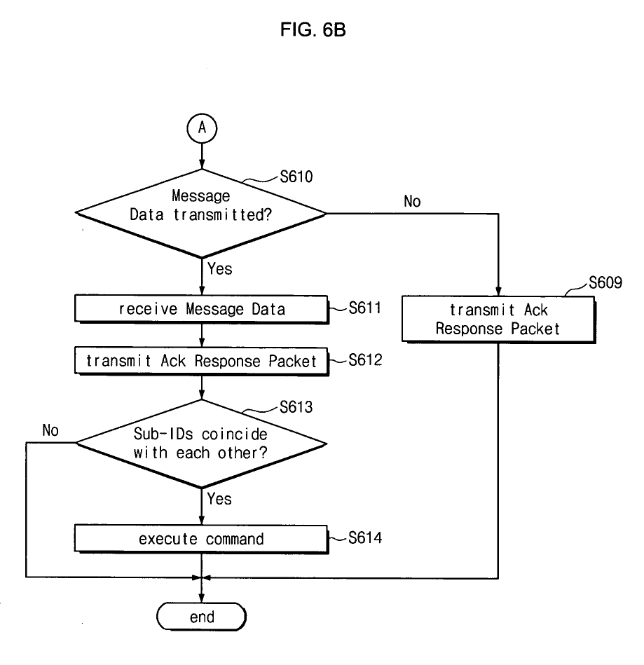

FIGS. 6a and 6b are flowcharts showing a telemetry method using a single shared address in accordance with an embodiment of the present invention.

Referring to FIGS. 6a and 6b, when the telemetric devices 100-1 to 100-n transmit a transmission request command (Inbound Message Request Packet), that is, a command providing notification of the current transmission of messages containing information collected and stored by them, to the communication network 300 in the form of an RF signal at step S601, the communication network 300 transmits a certain command to the telemetric devices 100-1 to 100-n in the form of an RF signal in response to the transmission request command (Inbound Message Request Packet) at step S602.

At step S601, when at least one of the telemetric devices 100-1, . . . , 100-(n−1) or 100-n transmits an transmission request packet (Inbound Message Request Packet) providing notification of the transmission of a message in the form of an RF signal, information providing notification of the size of the message to be transmitted is transmitted along with the transmission request command (Inbound Message Request Packet). Accordingly, the communication network 300 becomes aware of the size of the message to be transmitted by the telemetric device 100-1, . . . , 100-(n−1) or 100-n in advance. Since the communication network 300 is aware of the size of the message to be transmitted in advance, the communication network 300 transmits a message termination command (End Of Text; EOT) providing notification of the termination of reception to the telemetric devices 100-1 to 100-n when the message corresponding to the known size has all been received.

When the communication network 300 transmits a command in the form of an RF signal, the telemetric device 100-1, . . . ,100-(n−1) or 100-n determines whether the command received from the communication network 300 is a transmission approval message (Schedule Inbound Message Command vector), that is, a command approving the transmission of messages containing information, at step S603. If the received command is the transmission approval message, the telemetric device 100-1, . . . ,100-(n−1) or 100-n determines whether the transmission approval command is a response to the transmission request command (Inbound Message Request Packet) that is transmitted by it at step S604. If, as a result of the determination at step S604, the transmission approval command is a response to the transmission request command (Inbound Message Request Packet) that is transmitted by the telemetric device 100-1, . . . ,100-(n−1) or 100-n, the telemetric device 100-1, . . . ,100-(n−1) or 100-n transmits a message (SAU&DU) containing certain information to the communication network 300 in the form of an RF signal at step S605.

If, as a result of the determination at step S604, the transmission approval command is not a response to the transmission request command that is transmitted by the telemetric device 100-1, . . . , 100-(n−1), or 100-n, the telemetric device 100-1, . . . , 100-(n−1), or 100-n does not transmit a message (SAU&DU) containing certain information and terminates the communication.

If, as a result of the determination at step S603, the transmission approval command (Schedule Inbound Message Command vector) has not been received, the telemetric device 100-1, . . . , 100-(n−1), or 100-n determines whether a message termination command (EOT), that is, a command providing notification of the termination of transmission of a message, has been received at step S606.

If, as a result of the determination at step S606, the message termination command has been received, the telemetric device 100-1, . . . , 100-(n−1), or 100-n determines whether the received message termination command is a response to the transmission request command (Inbound Message Request Packet) transmitted by it at step S607.

If, as a result of the determination at step S607, the message termination command is a response to the transmission request command, the telemetric device 100-1, . . . , 100-(n−1), or 100-n transmit an Ack, that is, a command providing notification of the normal reception of the message, to the communication network 300 in the form of an RF signal at step S608. In this case, the telemetric device 100-1, . . . , 100-(n−1), or 100-n manages the MSN, which is managed inside the telemetric device 100-1, . . . , 100-(n−1), or 100-n and is related to the reverse channel, by updating it at step S609.

If, as a result of the determination at step S606, the message termination command has not been received, the telemetric device 100-1, . . . , 100-(n−1), or 100-n determines whether the telemetric server 200 has transmitted an address signal (Address&Message vector) and a message request command requesting data, or whether the telemetric server 200 has transmitted an address signal and a certain command without transmitting a message request command at step S610.

If, as a result of the determination at S610, the address has been input by the user, that is, if the user has input the shared address of the group of telemetric devices 100 to the telemetric server 200 and has directed the communication, the telemetric server 200 transmits the input address to the group of telemetric devices 100 in the form of an RF signal via the communication network 300. Furthermore, the telemetric server 200 transmits message request command (Message Data), that is, a command requesting data from the address input by the user, to the telemetric devices 100-1 to 100-n via the communication network 300, with the sub-ID of the telemetric device 100-1, . . . , 100-(n−1), or 100-n, which is input by the user, being attached to the message request command.

If, as a result of the determination at step S610, the address signal (Address&Message vector) and the message request command have been transmitted, the telemetric devices 100-1 to 100-n receive the message request command (Message Data) with the sub-ID attached thereto, that is, a command that is transmitted by the telemetric server 200 and requests data, via the communication network 300 at step S611. When the message request command has been received, the master telemetric device 100-1 transmits a reception response command (Ack Response Packet), that is, a response providing notification of the reception of the message request command, to the telemetric server 200 via the communication network 300 in the form of an RF signal at step S612.

Meanwhile, the telemetric devices 100-1 to 100-n of the group of telemetric devices 100 determine whether the sub-ID attached to the message request command matches one of their sub-IDs at step S613. If, as a result of the determination, there is a match, one of the telemetric devices 100-1 to 100-n having a sub-ID identical to the received sub-ID executes the received message request command at step S614. For example, when the telemetric device is attached to a water meter and the received message request command requests the measured amount of water used, the telemetric device reads the measured amount of water used and transmits the read value to the telemetric server 200 via the communication network 300.

If, as a result of the determination at step S613, there is no match, the group of telemetric devices 100 terminates the communication.

Meanwhile, if, as a result of the determination at step S610, the telemetric server 200 has transmitted the address signal (Address&Message vector) and the certain command in the form of an RF signal but does not transmit the message request command, the master telemetric device 100-1 transmits a reception response command (Ack Response Packet) providing notification of the command to the telemetric server 200 via the communication network 300 in the form of an RF signal at step S615.

As described above, in accordance with the present invention, a plurality of telemetric devices managing and controlling watt-hour meters, water and gas meters and vending machines and a telemetric server communicates with each other using a single shared address, thus improving the efficiency of use of addresses and considerably reducing costs. As a result, a technology of managing and controlling various types of measuring equipment or electronic equipment using the telemetric devices can be commercialized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A telemetry system for managing and controlling a plurality of target devices, such as vending machines, water meters, gas meters and watt-hour meters, the system comprising:
a group of telemetric devices attached to the target devices, respectively, and assigned a single shared address;
a telemetric server configured to remotely manage and control the group of telemetric devices; and
a two-way communication network configured to perform data communication between the group of telemetric devices and the telemetric server;
wherein the group of telemetric devices comprises a plurality of telemetric devices located adjacent to each other in a specific area, one of the group of telemetric devices is set as a master telemetric device and remaining ones are set as slave telemetric devices, and the master telemetric device and the slave telemetric devices are assigned unique sub-IDs.

2. The system as set forth in claim 1, wherein:
the master telemetric device communicates with the communication network using the shared address, manages the slave telemetric devices via the communication network, transmits a response providing notification of reception of a message request command and a certain command via the communication network in Radio Frequency (RF) form when the message request command or the certain command is received at the shared address via the communication network, collects and stores information about a target device to which the master telemetric device is attached, manages and controls the target device, and transmits a message containing stored information via the communication network in RF signal form as a message request command requesting the information and a sub-ID of the master telemetric device are received via the communication network;
each of the slave telemetric devices communicates with the communication network using the shared address in RF signal form, collects and stores information about a target device to which the slave telemetric device is attached, manages and controls the target device, and transmits a message containing stored information via the communication network in RF signal form as a message request command requesting the information and a sub-ID of the slave telemetric device are received via the communication network; and
the telemetric server transmits the shared address, the sub-IDs of the master telemetric device and the slave telemetric devices, the message request command and the certain command to the master telemetric device and the slave telemetric devices via the communication network, and receives commands and messages from the master telemetric device and the slave telemetric devices via the communication network.

3. The system as set forth in claim 1, wherein the master telemetric device is set with a master flag that allows a device to function as a master, and the slave telemetric devices are set with slave flags that allow devices to function as slaves.

4. The system as set forth in claim 1, wherein each of the master telemetric device and the slave telemetric devices stores certain frequency information, and communicates with the communication network using the frequency information.

5. The system as set forth in claim 4, wherein the master telemetric device requests communication registration from the communication network using the frequency information when the master telemetric device and the slave telemetric devices are not communicatively connected to the communication network and want to perform the communication registration.

6. The system as set forth in claim 5, wherein the slave telemetric devices are automatically and communicatively connected to the communication network without a request for to communication registration when the communication network approves the communication registration request of the master telemetric device and sets up a communication connection with the master telemetric device.

7. The system as set forth in claim 1, wherein different frames for transmission and reception are set for the master telemetric device and the slave telemetric devices for respective sub-IDs, and the master telemetric device and the slave telemetric devices transmit messages and commands via the set frames.

8. The system as set forth in claim 1, wherein a period of transmission of information is set for the master telemetric device and the slave telemetric devices, and messages containing certain information are automatically transmitted to the telemetric server at intervals corresponding to the set period of transmission.

9. The system as set forth in claim 1, wherein the master telemetric device stores information about a number of slave telemetric devices.

10. The system as set forth in claim 1, wherein only the master telemetric device responds to a communication command transmitted by the communication network when the communication network transmits the communication command to the shared address.

11. The system as set forth in claim 1, wherein the telemetric server attaches the sub-ID to the message request command or the certain command and transmits the message request command or the certain command with the sub-ID attached thereto.

12. A telemetry method of remotely reading and managing target devices, such as vending machines, water or gas meters, or watt-hour meters, using a telemetric server communicating with a master telemetric device and slave telemetric devices attached to the target devices, respectively, via a two-way communication network, the method comprising;
a step 1 at which at least one of the master telemetric device and the slave telemetric devices transmits an transmission request command providing notification of transmission of a message to the communication network using a shared address in advance, and transmits the message containing certain information to the communication network in RF signal form as a transmission approval command approving the transmission of the message to the shared address is received from the communication network in response to the transmission request command;
a step 2 at which at least one of the master telemetric device and the slave telemetric devices transmits a normal response command providing notification of normal reception of the message to the communication network in RF signal form as the communication network transmits a message termination command providing notification of termination of reception of the message using the shared address in response to the transmission request command;
a step 3 at which the master telemetric device transmits a reception response command providing notification of reception of a message request command to the telemetric server via the communication network in RF signal form as the telemetric server transmits the message request command requesting information using the shared address and a sub-ID of at least one of the master telemetric device and the slave telemetric devices via the communication network; and
a step 4 at which one of the master telemetric device and the slave telemetric devices, which has a sub-ID coinciding with the sub-ID transmitted from the telemetric server, executes the message request command transmitted by the telemetric server.

13. The method as set forth in claim 12, further comprising a step 5 at which the master telemetric device transmits a reception response command providing notification of reception of a certain command to the telemetric server via the communication network in RF signal form as the telemetric transmits the certain command via the communication network using the shared address.

14. The method as set forth in claim 12, wherein the step 1 comprises:
a step 1-1 at which the one of the master telemetric device and the slave telemetric devices transmits the transmission request command to the communication network;
a step 1-2 at which the communication network transmits the certain command to the one of the master telemetric device and the slave telemetric devices in response to the transmission request command;
a step 1-3 at which the master telemetric device and the slave telemetric devices determines whether the certain command transmitted by the communication network is the transmission approval command;
a step 1-4 at which the process proceeds to the step 2 if, as a result of the determination, the certain command is the transmission approval command;
a step 1-5 at which the one of the master telemetric device and the slave telemetric devices determines whether the server does not transmit the message request command but transmission approval command is a response to the transmission request command transmitted by it;
a step 1-6 at which the one of the master telemetric device and the slave telemetric devices transmits the message containing certain information to the communication network if, as a result of the determination at the step 1-5, the transmission approval command is a response to the transmission request command transmitted by it; and
a step 1-7 at which the one of the master telemetric device and the slave telemetric devices does not transmit the message and terminates communication if, as a result of the determination at the step 1-5, the transmission approval command is not a response to the transmission request command transmitted by it.

15. The method as set forth in claim 12, wherein the step 2 comprises:
a step 2-1 at which the one of the master telemetric device and the slave telemetric devices determines whether the message termination command has been received from communication network;
a step 2-2 at which the process proceeds to the step 3 if, as a result of the determination at the step 2-1, the message termination command has not been received from the communication network;
a step 2-3 at which the one of the master telemetric device and the slave telemetric devices determines whether the message termination command is a response to the transmission request command transmitted by it if, as a result of the determination at the step 2-1, the message termination command has been received from the communication network;
a step 2-4 at which the one of the master telemetric device and the slave telemetric devices transmits the normal response command to the communication network if, as a result of the determination at the step 2-3, the message termination command is a response to the transmission request command transmitted by it; and
a step 2-5 at which the one of the master telemetric device and the slave telemetric devices terminates communication with the communication network if, as a result of the determination at the step 2-3, the message termination command is not a response to the transmission request command transmitted by it.

16. The method as set forth in claim 15, wherein the step 2 further comprises a step 2-6 at which the one of the master telemetric device and the slave telemetric devices updates a Message Sequence Number (MSN) relating to a reverse channel after transmitting the normal response command.

17. A telemetric device attached to a target device, such as a vending machine, water or gas meter, or a watt-hour meter, and configured to manage and control the target device and exchange messages and various commands with a telemetric server via a two-way communication network, the telemetric device comprising:
storage means for storing a shared address, information about the target device, a sub-ID for identification thereof, frame information for prevention of collisions between transmitted data, a flag for distinguishing between a master and a slave and frequency information for communication with the communication network;
control means for performing control using the frequency information stored in the storage means so that the telemetric device and the communication network communicates in synchronization with each other, storing information, which is provided via the communication network, in the storage means, collecting information about the target device and storing the information about the target device in the storage means, providing the information stored in the storage means and controlling the target device in compliance with a command of the telemetric server received via the communication network, and transmitting information via the frames stored in the storage means; and
Radio Frequency (RF) transmission and reception means for converting an RF signal, which is received from the communication network, into a digital baseband signal and transferring the digital baseband signal to the control means, and converting a digital baseband signal, which is transferred from the control means, into an analog RF signal and transmitting the analog RF signal to the communication network, under control of the control means.

18. The device as set forth in claim 17, wherein the storage means stores a period of transmission at which certain information is automatically transmitted is stored, and the control means automatically transmits the stored information at intervals corresponding to the stored period of transmission.

19. The device as set forth in claim 17 or 18, wherein the control means performs a master function if the flag stored in the storage means is a flag for a master, and performs a slave function if the flag stored in the storage means is a flag for a slave.

20. A telemetry system for managing and controlling a plurality of target devices, such as vending machines, water meters, gas meters and watt-hour meters, having:
a group of telemetric devices attached to the target devices, respectively and assigned a single shared address;
a telemetric server configured to remotely manage and control the group of telemetric devices; and
a two-way communication network configured to perform data communication between the group of telemetric devices and the telemetric server;
wherein the telemetric devices are assigned unique sub-IDs, frames to be transmitted are distinguished according to the assigned sub-IDs, and the telemetric devices and the communication network are newly synchronized and then transmit data whenever they transmit the data.
